(19) United States
(12) Patent Application Publication
(10) Pub. No.: US 2023/0403224 A1
(43) Pub. Date: Dec. 14, 2023

(54) DETERMINING COMPREHENSIVE HEALTH SCORES FOR MACHINES HOSTING VIRTUAL DESKTOPS BASED ON PERFORMANCE PARAMETERS

(71) Applicant: Citrix Systems, Inc., Fort Lauderdale, FL (US)

(72) Inventors: Vinay George Roy, Bangalore (IN); Vikramjeet Singh Sandhu, Bangalore (IN); Mukesh Garg, Bangalore (IN); Vijay Nagarajan, Bangalore (IN); Vindhya Gajanan, Bangalore (IN); Abhyudaya Anand, Bangalore (IN); Prabhjeet Singh Chawla, Bangalore (IN)

(21) Appl. No.: 17/840,432

(22) Filed: Jun. 14, 2022

(51) Int. Cl. H04L 43/091; H04L 41/16

(52) U.S. Cl. CPC H04L 43/091; H04L 41/16

(57) ABSTRACT

Described embodiments provide systems and methods for classifying a machine by performance. A device may identify, for a first time window, a first plurality of attributes of a machine and a session provided by the machine. The device may determine a first score based at least on a weight applied to each of the first plurality of attributes. The weight may be updated using a second plurality of attributes of the machine and the session provided by the machine for a second time window. The device may determine a probability of failure for the session by applying the first plurality of attributes to a model. The device may generate a second score indicating a performance of the machine as a function of the first score and the probability of failure. The device may classify the machine into a performance level in accordance with the second score.

### FIELD OF THE DISCLOSURE

The present application generally relates to network communications. In particular, the present application relates to systems and methods for classifying machines by performance.

### BACKGROUND

A client may access a resource hosted on a server over a network. The accessing of the resource as experienced by a user of the client may be affected by various factors within the network.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

In a computer networked environment, a client may access resources for an application hosted on a server via a session provided by a machine (sometimes herein referred to as a delivery agent). The machine may be one of many maintained by a gateway between the client and the server, and the session supported by the machine may provide a virtual desktop through which the application can be accessed. The experience of the user in accessing the resources for the application may depend on the machine and the session.

To ensure smooth user experience, the machine should be in a healthy state, as the state may correlate with uninterrupted sessions, better performance, and successful launches, among others. Thus, maintaining the health of the machines may be useful in providing high-quality user experience to the client. Measuring, let alone maintaining, the health of machines may be a challenging task, especially from the perspective of an administrator of the machines. There may be several metrics, logs, and data points that the administrator may manually view and validate in determining whether a specific machine is healthy. Given the myriad of factors to consider, it may be difficult for the administrator to manually decide and conclude whether the machine is healthy or poor and to undergo further diagnosis.

One approach in identifying machines with poor performance may be to flag a particular machine upon continuous failures in launching a session. For example, a reactive mechanism may be put in place such that a machine with four consecutive failures is marked and the administrator is alerted. The issue with this approach, however, may be that user experience has already suffered by the time that the administrator is alerted about the machine. Another approach to account for some of these issues may entail having an algorithm to predict whether a machine will have poor performance by looking to past session data. While this approach may find chronically poor machines, the approach may suffer from the inability to identify machines with moderately poor or fair performance. The inability may prevent administrators from undertaking pre-emptive measures, due to unawareness of the status of such machines.

To address these and other challenges, a service may determine a comprehensive health score for each machine to indicate the overall health of each machine and to classify the machine by performance level. In determining, the service may aggregate a set of attributes for the machine and session provided by the machine. The set of attributes may include those that could affect the health and performance of the machine. These may be assessed using both subject matter knowledge and data-driven exploration to formulate a comprehensive formula reflective of the overall health of the machine. The assessment may be run over a set time interval, collecting the data for the identified attributes and calculating the score for each machine. The comprehensive health score may be calculated as a weighted sum of the formulas and algorithms. The weights may be dynamic and evolving as more and more data are accumulated for the machine and session. The weights may be bootstrapped using subject matter expertise while also allowing for adaptation with respect to the data correlations.

The set of attributes used to calculate the comprehensive health score may include attributes related to resource consumption, attributes related to user experience, and attributes related to session performance, among others from a current time window for the machine. For example, the set of attributes related to resource consumption may include available processing power, available memory, available disk capacity, input/output (I/O) operations over time, and scaled load index, among others. The set of attributes related to user experience may include a user experience score across a set of machines, a user experience score over previous sessions for the particular machine, round trip time (RTT) for presentation, and rendering time, among others. The set of attributes related to session performance may include session failure rate and number of session launches on the machine, among others. The session failure rate may be weighted based on a recency of the session, with session failures closer to the current time having a higher weight. The weight may be in accordance with an exponential moving average (EMA) and weighted moving average (WMA), among others.

Using these attributes, the service may combine the attributes into a set of score components using different algorithms and to produce a single, comprehensive health score. As described previously, the service may use an adaptive weighting scheme to aggregate both domain knowledge and data-based insights and evolving using machine learning (ML). The service may calculate a static score component based on weights assigned in accordance with subject matter expertise (SME). The set of weights may be static and may be common across various machines. In calculating, the service may apply each static weight to the static score component.

In addition, the service may determine an adaptive score component by using weights that are dynamically updated based on data accumulated about the machine. The weights may be updated to give more or less importance to the attributes affecting the performance of the machine or the session. The correlations between the attributes and the successful launch or failure of previous sessions may be used to update and develop the weights. The adaptive weights may be divided on the basis of the correlation. For example, the session may use an ensemble tree model trained on the session data for the machine over a past time window (e.g., previous week) to predict the session launch result using the same attributes. Once trained, the weights may be assigned using the parameters of the ensemble tree model according to the ratio of parameters. The updating of the weights may be performed on a defined interval (e.g., daily). By applying the weights to the corresponding currently aggregated attributes, the service may calculate the adaptive score component.

Furthermore, the service may calculate a ML score component using a model to predict session failure from the set of attributes over the current time window. The model may be trained in a supervised manner using on history of sessions and the corresponding attributes for the sessions. The following data may be used to train the model: the set of attributes from the current time window, the number of different users over a past set number of sessions, the number of different applications in the previous set number of sessions, the session failure statuses of the previous sessions, and applications on the machine, among others. The model may be trained and updated at a set interval of time based on an amount of historic data. By applying the model to the attributes from the current time window, the service may calculate the probability of failure of the session provided by the machine. The probability may be used as the ML score component.

With the calculations of the score components, the service may generate the comprehensive health score for the machine as a weighted sum. The weights for each score component may be set to initial values. Failsafe measures may be used to ensure that issues with the ML model (e.g., data drifts) does not affect the overall score. The setting of the weights may be based on performance metrics of the model, such as accuracy, precision, and recall, among others. If the performance measures on an evaluation set are above certain thresholds, the weight for the model may be increased. Conversely, if the performance measures are below the thresholds, the weight for the model may be decreased. In some cases, the weights may be set so that the overall score is dependent on the SME based score component.

The health score for the machine may be modified using a correction factor. The correction factor may be determined using an interface for troubleshooting the machines. The interface may be used to check and report for errors with varying levels of severity. The errors may have an impact on the health of the machine, independent of the other attributes. The errors may be categorized into different levels of severity, and the correction factor may be applied as an adjustment (e.g., a penalty value) to the health score.

Using the comprehensive health score, the service may classify the machine into a performance level (e.g., bad, fair, good, or excellent). The service may use a set of ranges for the scores to classify the machine into the performance level. The set of ranges may be static or dynamically adjusted. For example, based on the history data for the sessions launched by the machine, the service may adjust the ranges of the scores for the performance level. The service may set a range of scores for each of the performance levels based on a set percentage of session launches that were failures. These levels may be periodically changed, as more and more data regarding the sessions are collected for the machine. To accommodate for this, the service can either move the thresholds at a fixed period or scale the scores in a way that the thresholds occur at the same numerical value.

In this manner, the health score may take into consideration many parameters, such as resource consumption, user experience, and session performance trends, among others. The health score may be used as a guideline for load balancing, resource provisioning, and assignment of machines to users, among others. The schema for scoring may leverage both domain-knowledge as well as data-based insights using machine learning approaches with the ability to continuously learn while ensuring robustness. The combination of the machine learning approach with the fail-safe methodology based on domain knowledge may provide a defense against common pitfalls for machine learning techniques. The comprehensive health score may also provide insight and can be drilled down upon for additional diagnosis regarding the health and performance of the machine and the session. The score may be used to improve the overall performance of machine and provide a session with better user experience.

Aspects of the present disclosure relate to systems, methods, and non-transitory media for classifying a machine by performance. A device may identify, for a first time window, a first plurality of attributes of a machine and a session provided by the machine. The device may determine a first score based at least on a weight applied to each of the first plurality of attributes. The weight may be updated using a second plurality of attributes of the machine and the session provided by the machine for a second time window. The device may determine a probability of failure for the session by applying at least one of the first plurality of attributes to a model. The device may generate a second score indicating a performance of the machine as a function of the first score and the probability of failure. The device may classify the machine into one of a plurality of performance levels in accordance with the second score.

In some embodiments, the device may determine a third score based at least on a second weight applied to each of the first plurality of attributes. The second weight may be maintained through the first time window and the second time window. In some embodiments, the device may generate the second score as the function of the first score, the probability of failure, and the third score.

In some embodiments, the device may identify, via an interface, a factor to indicate a difference between the second score and the performance of the machine. In some embodiments, the device may modify the second score in accordance with the factor. In some embodiments, the device may determine, for the first plurality of attributes, an attribute indicating a trend of session failure as a second function to weigh a status for each of a plurality of sessions previously provided by the machine by recency.

In some embodiments, the device may train the model for determining the probability of failure using a dataset comprising at least one of a number of different users from a plurality of sessions previously provided by the machine, a number of different applications accessed via one of the plurality of sessions, and a status for each of the plurality of sessions.

In some embodiments, the device may update a second model including the weight to be applied, using the second plurality of attributes of the machine and a third score generated indicating the performance of the machine during the second time window. In some embodiments, the device may provide output based at least on a classification of the machine into one of the plurality of performance levels.

In some embodiments, the device may determine the probability of failure by applying at least one of the first plurality of attributes to the model. The model may be updated using a third plurality of attributes of the machine and the session provided by the machine for a third time window greater than the second time windows.

In some embodiments, the device may apply a second weight to the first score and a third weight to the probability of failure. The second and the third weight may be updated from a third time window. In some embodiments, the first plurality of attributes may include a first attribute identifying a consumption of a resource of the machine, a second attribute identifying a user experience of the session provided by the machine, and a third attribute identifying a failure of the session.

### BRIEF DESCRIPTION OF THE DRAWING FIGURES

Objects, aspects, features, and advantages of embodiments disclosed herein will become fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of an embodiment of a system for classifying machines by performance levels based on comprehensive health scores in accordance with an illustrative embodiment;

FIG. 6A is a block diagram of an embodiment of a process for aggregating attributes in the system for classifying machines by performance levels in accordance with an illustrative embodiment;

FIG. 6B is a block diagram of an embodiment of a process for calculating health scores in the system for classifying machines by performance levels in accordance with an illustrative embodiment;

FIG. 6C is a block diagram of an embodiment of a process for applying classifications in the system for classifying machines by performance levels in accordance with an illustrative embodiment;

FIG. 6D is a block diagram of an embodiment of a process for managing scoring schemes in the system for classifying machines by performance levels in accordance with an illustrative embodiment;

FIGS. 7A and 7B each are block diagrams of an embodiment of function to weigh session statuses by recency for calculation of session trends in accordance with an illustrative embodiment;

FIG. 8 is a screenshot of an interface for providing information on classifications of machines by performance levels in accordance with an illustrative embodiment;

FIG. 9 is a flow diagram of an embodiment of a process of determining health scores of machines in accordance with an illustrative embodiment; and

FIG. 10 is a flow diagram of an embodiment of a method of classifying machines by performance levels based on comprehensive health scores in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment; and
Section E describes embodiments of systems and methods for classifying machines by performance levels based on comprehensive health scores.

### A. Network and Computing Environment

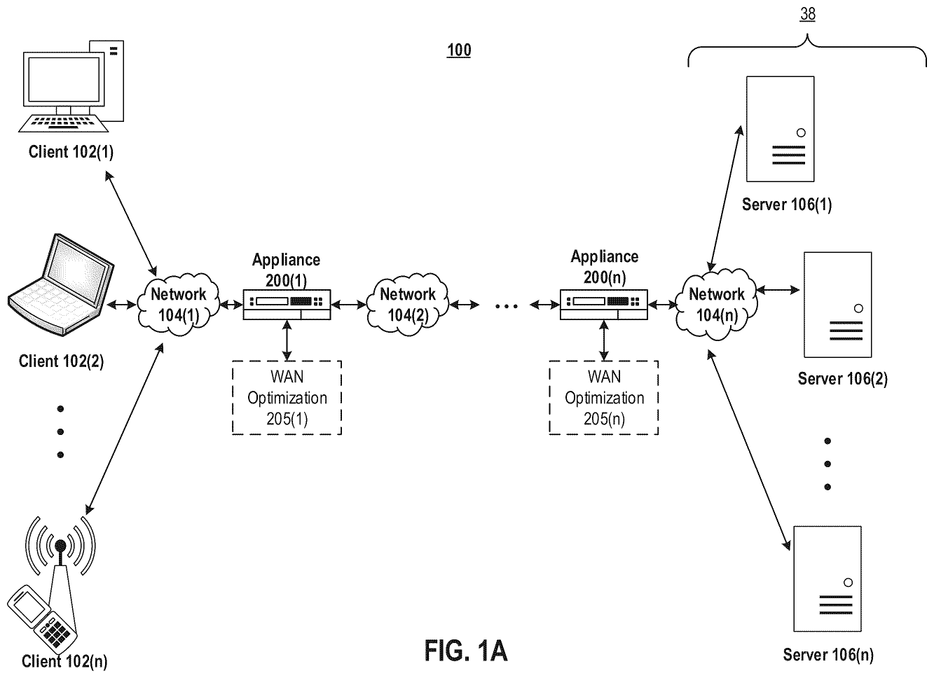

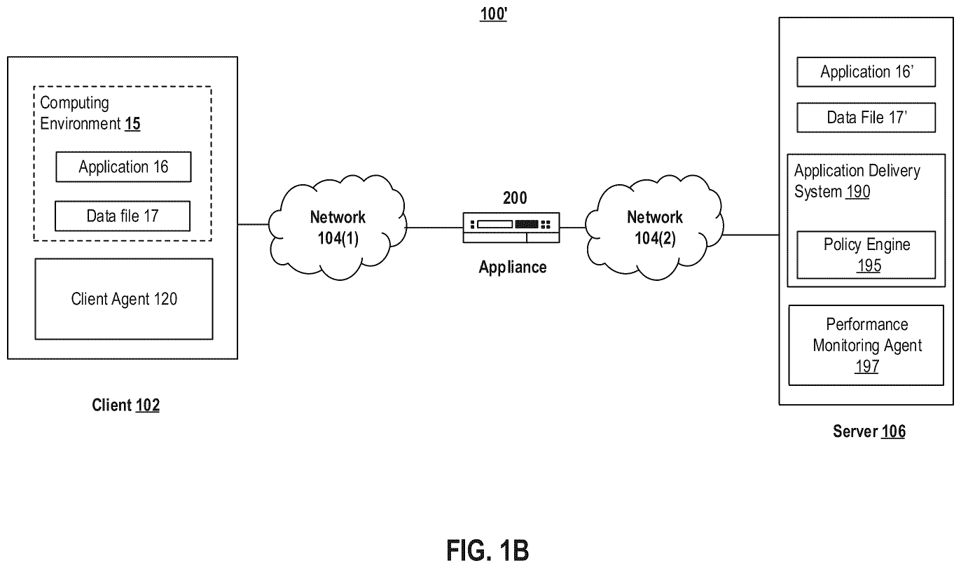

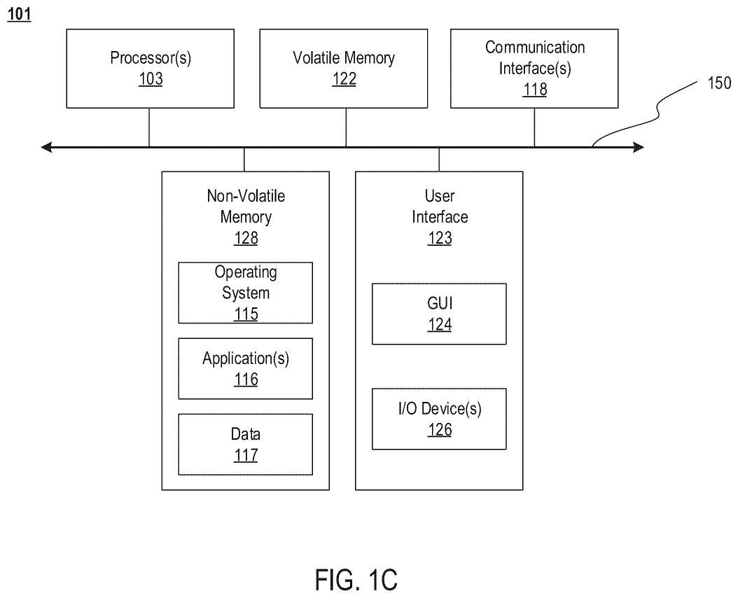

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as NetScaler® products sold by Citrix Systems, Inc., of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as CloudBridge® products sold by Citrix Systems, Inc., of Fort Lauderdale, FL.

Referring to FIG. 1B, an example network environment 100′ for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application 16 that accesses, processes or uses a data file 17. Computing environment 15, application 16 and/or data file 17 may be delivered to the client 102 via appliance 200 and/or the server 106.

Appliance 200 may accelerate delivery of all or a portion of computing environment 15 to a client 102, for example, by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example, via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as XenApp® or XenDesktop®.

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 102 for local execution.

For example, in operation, a client 102 may request execution of an application (e.g., application 16′) and application delivery system 190 of server 106 determines how to execute application 16′, for example, based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc., of Fort Lauderdale, FL. The application may be any application related to real-time data communications, such as applications for streaming graphics, streaming video and/or audio or other data, delivery of remote desktops or workspaces or hosted services or applications, for example, infrastructure as a service (IaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example, by software, hardware or a combination thereof. Performance monitoring may include one or more agents for performing monitoring, measurement and data collection activities on clients 102 (e.g., client agent 120), servers 106 (e.g., agent 197) or an appliances 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as EdgeSight by Citrix Systems, Inc., of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example, periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of one or more applications, one or more desktop applications, and one or more desktop sessions in which one or more applications may execute.

### B. Appliance Architecture

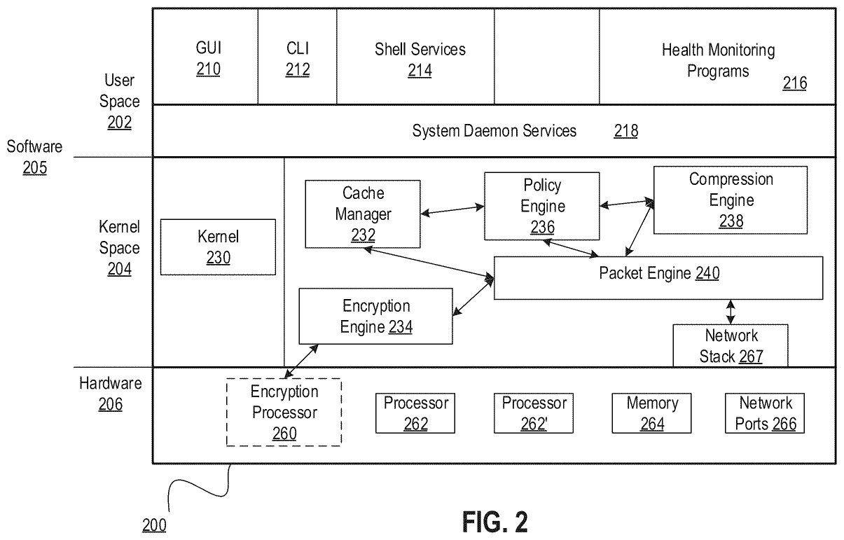

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and an encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example, since data obtained in kernel mode may not need to be passed or copied to a user process, thread or user level data structure.

Cache manager 232 may duplicate original data stored elsewhere or data previously computed, generated or transmitted to reduce the access time of the data. In some embodiments, the cache manager 232 may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example, between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example, to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example, by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine whether a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layers connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example, to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc., of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

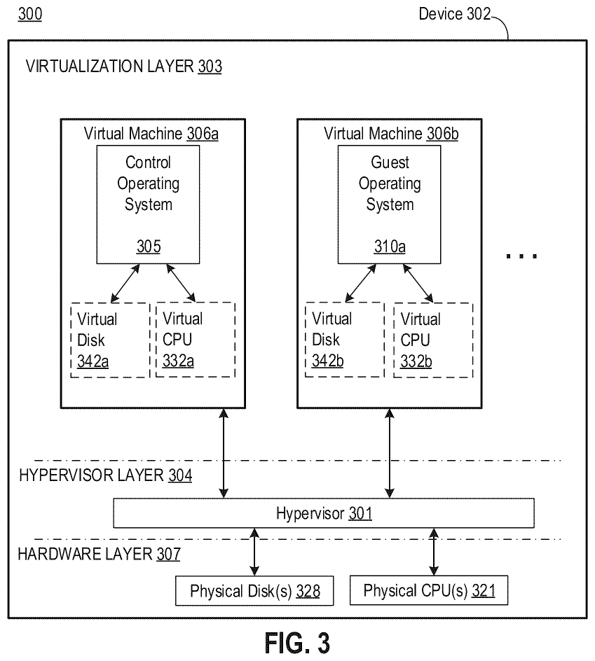

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocate and manage access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a XEN hypervisor, for example, as provided by the open source Xen.org community. In an illustrative embodiment, device 302 executing a hypervisor that creates a virtual machine platform on which guest operating systems may execute is referred to as a host server. In such an embodiment, device 302 may be implemented as a XEN server as provided by Citrix Systems, Inc., of Fort Lauderdale, FL.

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other VMs 306, for example, by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example, on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example, to balance the flows across the cores. For example, packet distribution may be based upon determinations of functions performed by each core, source and destination addresses, and/or whether a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example, via a hash table, indirection table, or other mapping technique.

### D. Systems and Methods for Providing a Distributed Cluster Architecture

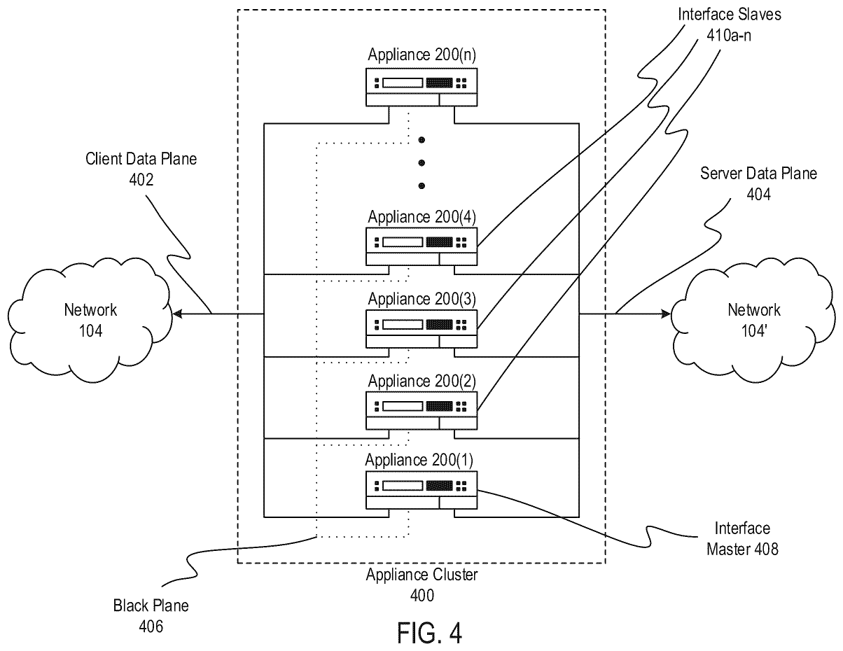

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a client-side network 104 via client data plane 402, for example, to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104′ via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

E. Systems and Methods for Classifying Machines by Performance Levels in Accordance with Comprehensive Health Scores.

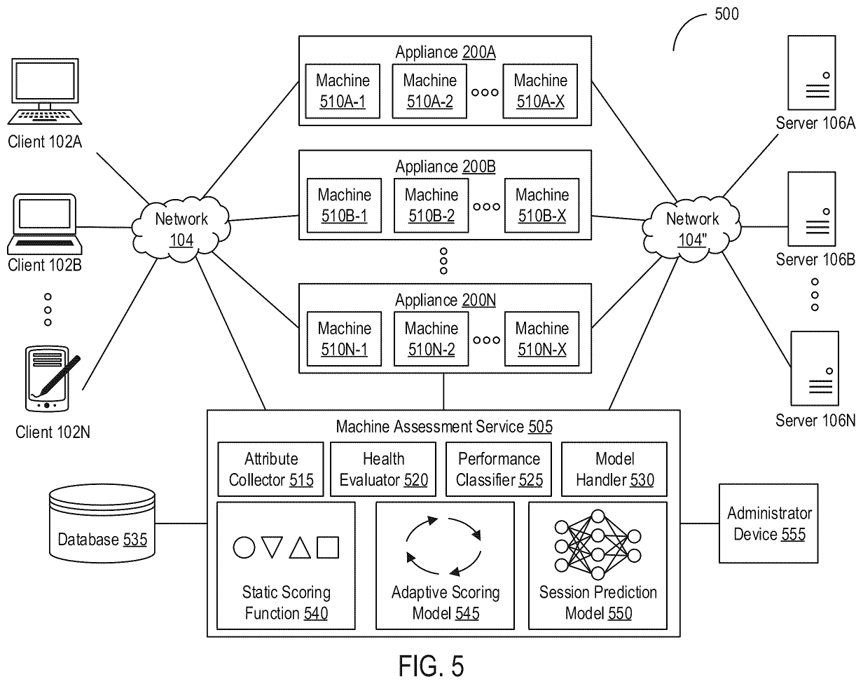

Referring now to FIG. 5, depicted is a system 500 for classifying machines by performance levels based on comprehensive health scores. In overview, the system 500 may include one or more clients 102A-N (hereinafter generally referred to as clients 102), one or more servers 106A-N (hereinafter generally referred to as servers 106), one or more appliances 200A-N (hereinafter generally referred to as appliances 200), and at least one machine assessment service 505, among others. The clients 102, the appliances 200, and the machine assessment service 505 may be communicatively coupled with one another via at least one network 104. The servers 106, the appliances 200, and the machine assessment service 505 may be communicatively coupled with one another via at least one network 104′.

Continuing on, each appliance 200 may host, maintain, or otherwise include one or more machines 510A-1 to 510N-X (hereinafter generally referred to as a machine). The machine assessment service 505 may include at least one attribute collector 515, at least one health evaluator 520, at least one performance classifier 525, and at least one model handler 530, among others. The machine assessment service 505 may include or have access to at least one database 535 (e.g., via the network 104 or 104′). The machine assessment service 505 may maintain or include at least one static scoring function 540, at least one adaptive scoring model 545, and at least one session prediction model 550, among others. The machine assessment service 505 may include, may be a part of, or may be communicatively coupled with at least one administrator device 555, among others. In some embodiments, the machine assessment service 505 may be part of one of the appliances 200 and interface with the one or more machine 510 on the appliance 200.

The systems and methods of the present solution may be implemented in any type and form of device, including clients 102, servers 106, or appliances 200. As referenced herein, a “server” may sometimes refer to any device in a client-server relationship, e.g., an appliance 200 in a handshake with a client device 102. The present systems and methods may be implemented in any intermediary device or gateway, such as any embodiments of the appliance or devices 200 described herein. Some portion of the present systems and methods may be implemented as part of a packet processing engine and/or virtual server of an appliance, for instance. The systems and methods may be implemented in any type and form of environment, including multi-core appliances, virtualized environments and/or clustered environments described herein. For example, each appliance 200 may be implemented using the virtualized environment 300 and the machines 510 on the appliance 200 in the system 500 may be an instances of virtual machine 306 as detailed above.

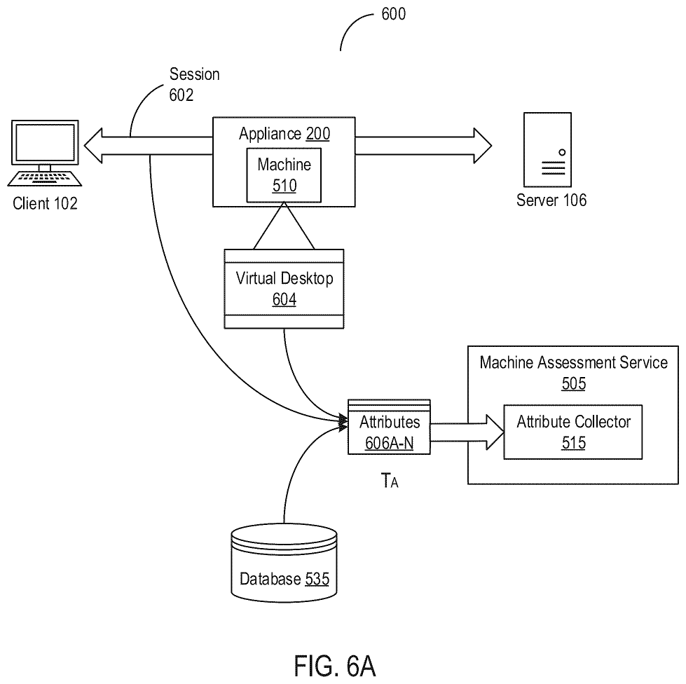

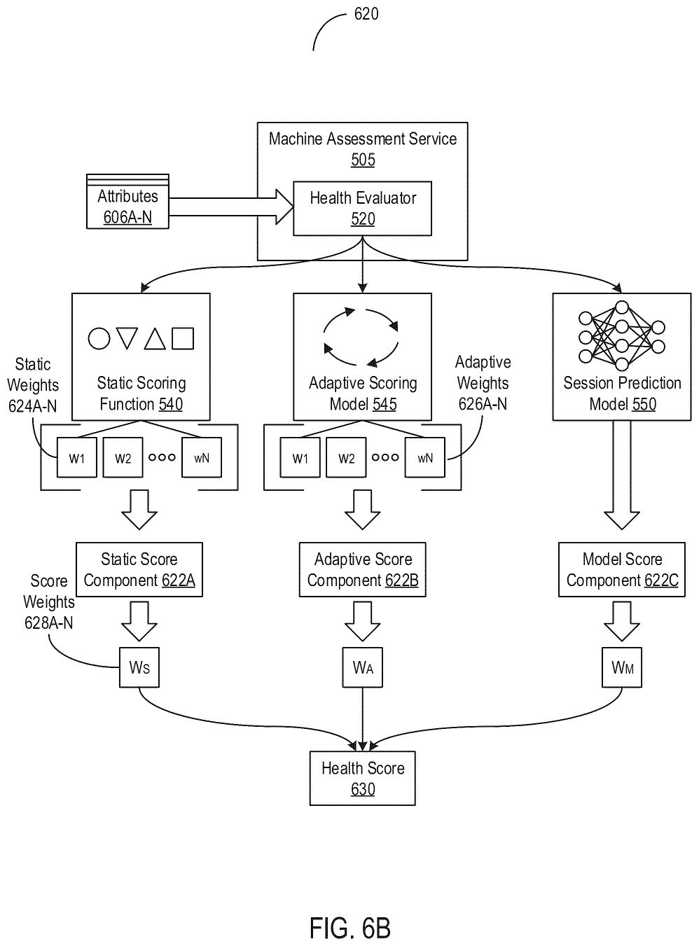

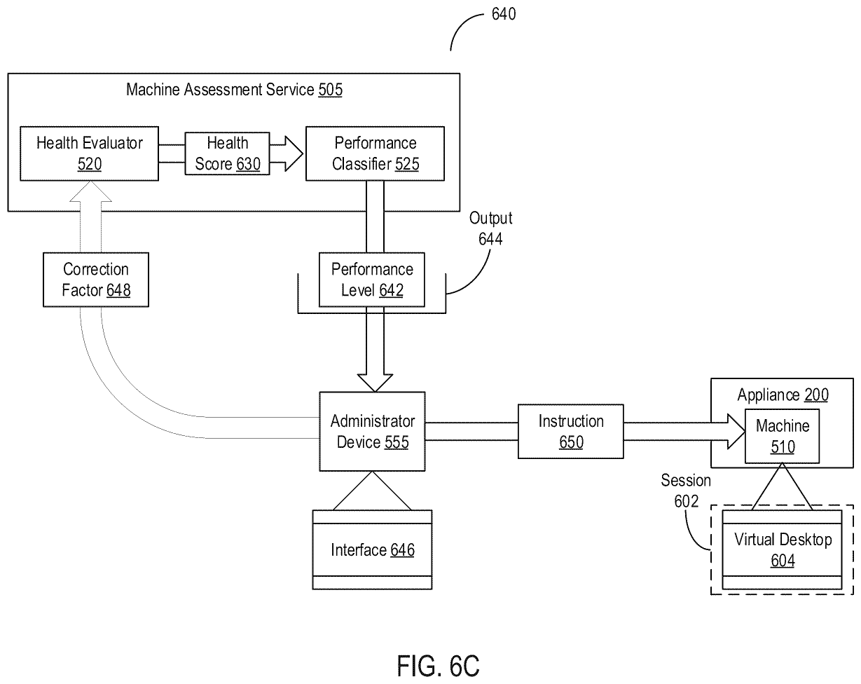

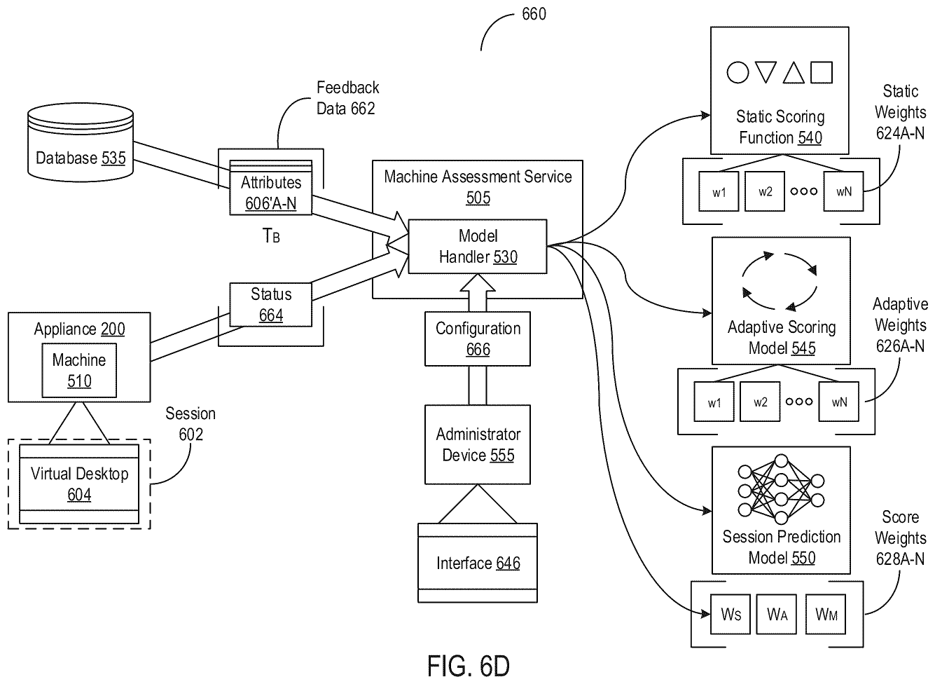

Referring now to FIG. 6A, depicted is a block diagram of a process 600 for aggregating attributes in the system 500 for classifying machines by performance levels. The process 600 may include or correspond to operations performed in the system 500 for collecting attributes of machines used to assess the health of the machines. For context, the client 102 may initiate and establish at least one session 602 with one of the machines 510 of the appliance 200 to access application resources hosted on the server 106. The session 602 may be established in accordance with any number of communication protocols, such as the Remote Desktop Protocol (RDP), the Independent Computing Architecture (ICA), or the Remote Frame Buffer (RFB) protocol, among others. The session 602 may be provided by the machine 510 on the appliance 200 to communicate data between the client 102 and the server 106. The session 602 may provide the client 102 access to an application whose resources are hosted on the server 106 at least in part. The application may be, for instance, a word processor, an image editor, a video editor, a video game, a web browser, and an electronic mail agent, among others. In some embodiments, one machine 510 may support or provide multiple sessions 602 and multiple corresponding virtual desktops 604 for users of clients 102.

With the establishment of the session 602, the machine 510 on the appliance 200 may provide at least one virtual desktop 604 for the session 602. The virtual desktop 604 may be a part of a physical or virtual machine (e.g., the virtual machine 306), and may be a graphical user interface (GUI) to facilitate accessing of the applications for the session 602. For example, the virtual desktop 604 may be a desktop environment for an operating system on the virtual machine to be provided to the client 102 for the session 602. In some embodiments, the machine 500 may modify, configure, or otherwise set the virtual desktop 604 to provide the client 102 access to the requested application. The provision of the virtual desktop 604 may correspond to a completion of the establishment of the session 602 between the client 102 and the machine 510 over the network 104. Upon establishment, various data regarding the machine 510, the session 602, and the virtual desktop 604 may be collected to assess the performance of the machine 510.

Under the process 600, the attribute collector 515 executing on the machine assessment service 505 may retrieve, receive, or otherwise identify a set of attributes 606A-N (hereinafter generally referred to as attributes 606). The set of attributes 606 may be of the machine 510 and at least one of the sessions 602 provided by the machine 510 for at least one time window T_{A}. Each attribute 606 may be a numeric value measuring, indicating, or identifying a performance metric, quality of user experience, or session status associated with the machine 510 or the session 602 provided by the machine 510. Each attribute 606 may be wrapped, organized, or arranged using a data structure, such as a linked list, tree, array, table, hash table, queue, stack, or heap, among others. For example, each attribute 606 may be arranged as a field-value pair in a table data structure, with the field indicating a type of attribute 606 and the value indicating a measure (e.g., numerical score) for the associated attribute 606.

At least some of the attributes 606 may be identified from the machine 510, the session 602 provided by the machine 510, or the virtual desktop 604 for the session 602, among others. The attribute collector 515 may access the machine 510, the session 602, or the virtual desktop 604 to measure, instrument, or otherwise identify the corresponding attributes 606. For example, the attribute collector 515 may access the machine 510 or the session 602 currently provided by the machine 510 at the time of identification of the attributes 606 to retrieve the attributes 606. At least some of the attributes 606 may be retrieved from the database 535. The attributes 606 may be stored and maintained on the database 535. With the identification of the attributes 606, the attribute collector 515 may store and maintain an association between the attributes 606 and the machine 510 or the session 602 on the database 535 for subsequent use. For instance, the attribute collector 515 may store and maintain the attributes 606 from the machine 510 and previous sessions 602 provided by the machine 510 on the database 535.

In identifying, the attribute collector 515 may identify or select the set of attributes 606 for the time window T_{A} to be used to assess the machine 510. In some embodiments, the attribute collector 515 may select the set of attributes 606 at a time interval. The time interval may span between minutes to weeks, and may be for example, an hour, a day, a set number of days, or a week, among others. The time window T_{A} may correspond to the span of the time interval at which the set of attributes 606 is identified. In some embodiments, the attribute collector 515 may identify the set of attributes 606 in response to an event on the appliance 200. The event may correspond to, for example, the request for initiation of the session 602, the establishment of the session 602, or a detection of failure on the machine 510 or the session 602 provided by the corresponding machine 510, among others. The time window T_{A} may be relative to the event, and may correspond to a set length of time prior to the event. For instance, the time window T_{A} may correspond to an hour, a day, a number of days, or a week prior to the present time corresponding to the detection of event.

The set of attributes 606 may identify or include one or more attributes 606 identifying a resource consumption on the machine 510 or the session 602 provided by the machine 510. The resources may correspond to a processor or memory used by the machine 510 or the network bandwidth consumed in providing the session 602, among others. At least one attribute 606 may include available processor capacity of the machine 510. For example, the attribute 606 may identify a percentage of a processor unit on the machine 510 available for processing operations. At least one attribute 606 may include available memory capacity of the machine 510. For instance, the attribute 606 may identify a percentage of memory available at the machine 510. At least one attribute 606 may include available storage space of the machine 510. For example, the attribute 606 may identify a percentage of available disk space relative to total capacity. At least one attribute 606 may include input/output (I/O) operations on the machine 510. For instance, the attribute 606 may identify I/O operations per second (IOPS) at the machine 510 normalized to a scale (e.g., a 0 to 100 value).

Continuing on, the set of attributes 606 may identify or include one or more attributes 606 correlated with or identifying user experience of the machine 510 or the session 602 provided by the machine 510. At least one attribute 606 may include a user experience metric across a given set of machines 510. The set of machines 510 may correspond to a delivery group, such as for an enterprise, a defined group of users, or appliances 200 at a given geographic location, among others. For instance, the user experience metric may be a standard score (also referred herein as a z-score) of the average metrics of the machine 510 across currently provided sessions 602 to an average of the standard scores across all machines 510 in the set. At least one attribute 606 may include a user experience metric for the machine 510. For example, the user experience metric may be a standard score of the average metrics of the machine 510 across currently provided sessions 602 to an average of the user experience metrics of the machine 510 over a set time window (e.g., time window T_{A}). Both of these standard scores may be calculated by the attribute collector 515, and may be normalized on a scale (e.g., 0 to 100). At least one attribute 606 may identify a deviation of network metric of communications in the session 602 from an expected or benchmark network metric. The network metric may be, for example, a round trip time (RTT), network delay, or latency affecting user experience of the session 602. The benchmark may be for the virtual desktop 604 provided by the session 602. The deviation may also be normalized on a scale (e.g., 0 to 100).

In addition, the set of attributes 606 may identify or include one or more attributes 606 correlated with or identifying a failure of one or more sessions 602 provided by the machine 510 or the machine 510 itself. At least one attribute 606 may include a trend of failure in sessions 602 provided by the machine 510. The trend of failure may be over a defined time window (e.g., time window T_{A}) or a set number of sessions 602 previously provided by the machine 510 (e.g., the most recent four to ten sessions 602). For each session 602 provided by the machine 510 over a defined time window (e.g., time window T_{A}), the attribute collector 515 may identify a status indicating success or failure in launching the session 602. The session status indication may be stored and maintained on the database 535, and the attribute collector 515 may fetch the status indications from the database 535.

With the identification, the attribute collector 515 may calculate, generate, or otherwise determine the attribute 606 for the trend of failure in sessions 602 provided by the machine 510 as a function of the status indications. The function may weigh the status indications by time instance or recency, for example, with the status indications for sessions 602 closer to the present weighted higher than status indications for sessions 602 further from the present. The function may be, for example, a moving average function, such as a weighted moving average (WMA) or an exponential moving average (EMA), among others. For instance, the weighted moving average may be of the following form:

$$W M {A}_{M} = \frac{{np}_{M} + ( n - 1 ) {p}_{M - 1} + … + 2 {p}_{( M - n ) - 2} + {p}_{( M - n ) + 1}}{n + ( n - 1 ) + … + 2 + 1}$$

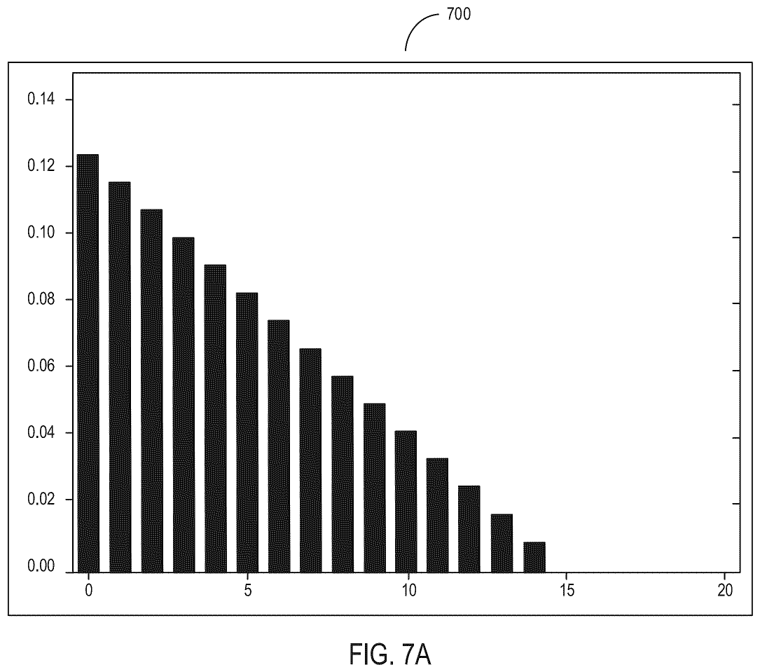

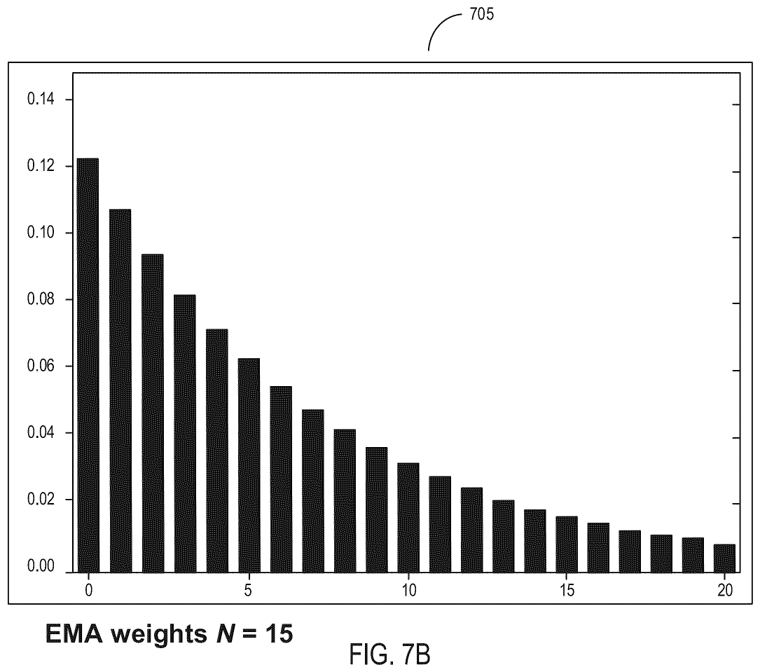

The weighted average may be an average with multiplying factors to give different weights to status indications at different time instances in the sample time window (e.g., as depicted in FIG. 7A). The exponential moving average may be a first order infinite impulse response filter applying weighting factors that decrease exponentially (e.g., as depicted in FIG. 7B). The weighting for status indications decrease exponentially and asymptotically towards zero. For each session 602, the attribute collector 515 may assign one numeric value for failure (e.g., 0) and another numeric value for success (e.g., 1). With the assignments, the attribute collector 515 may input the values for the status indications of the sessions 602 into the function to determine the trend of failure. The attribute collector 515 may insert, add, or otherwise include the trend of failure as one of the attributes 606 of the set.

In some embodiments, the attribute collector 515 may carry out or perform a data preprocessing on the set of attributes 606 identified for the machine 510 and the session 602 provided by the machine 510. The data preprocessing (or data preparation) may include normalizing or scaling of the value of each attribute 606. For each attribute 606, the attribute collector 515 may calculate or determine a scale value of the value for the attribute 606. The scaled value may be within a range of values (e.g., a scale of −1 to 1, 0 to 1, or 0 to 100). The attribute collector 515 may convey or provide the scaled values as the set of attributes 606 to the other components of the machine assessment service 505.

Referring now to FIG. 6B, depicted is a block diagram of a process 620 for calculating health scores in the system 500 for classifying machines by performance levels. The process 620 may correspond to or include operations in the system 500 for amalgamating the values of attributes according to scoring schemes to determine comprehensive health scores. Under the process 620, the health evaluator 520 executing on the machine assessment service 505 may calculate, generate, or otherwise determine a set of score components 622A-C (hereinafter generally referred to as score components 622) using the set of attributes 606. Each score component 622 may represent a measure of the performance of the machine 510 as defined by the respective scoring scheme. The scoring schemes may include, for example, the static scoring function 540, the adaptive scoring model 545, and the session prediction model 550.

The health evaluator 520 may determine at least one static score component 622A using the set of attributes 606 in accordance with the static scoring function 540. The static scoring function 540 may identify or include a set of static weights 624A-N (hereinafter generally referred to as static weights 624) to be applied to the corresponding set of attributes 606. The static weights 624 may be set or configured to be applicable across different machines 510, and may be held constant through multiple time windows (e.g., the time window T_{A} and another time window T_{B}). Each static weight 624 may identify or include a value (denoted as wᵢ) to apply to a corresponding attribute 606 (denoted as Xᵢ). The values of the static weights 624 may be assigned based on subject matter experience or domain knowledge. For example, the static weights 624 may be assigned to apply 10% weight to attributes 606 related to user experience, 30% weight to attributes 606 related to performance of the sessions 602, and 20% weight to attributes 606 related to performance of the machine 510, among others. In determining the static score component 622A, the health evaluator 520 may apply the static weight 624 to the corresponding attribute 606. From applying, the health evaluator 520 may generate a product of the static weight 624 with each corresponding attribute 606 (wᵢ×Xᵢ). With the generation, the health evaluator 520 may calculate a sum of the products across the set of attributes 606. Upon calculating, the health evaluator 520 may identify or use the sum as the static score component 622A. The static score component 622A may be included by the health evaluator 520 into the set of score component 622.

Furthermore, the health evaluator 520 may determine at least one adaptive score component 622B based on the adaptive scoring model 545 applied to the set of attributes 606. The adaptive scoring model 545 may identify or include a set of adaptive weights 626A-N (hereinafter generally referred to as adaptive weights 626) to be applied to the corresponding set of attributes 606. In some embodiments, the set of adaptive weights 626 may be applied to set of attributes 606 for a particular machine 510, with each machine 510 associated with a respective set of adaptive weights 626. In some embodiments, the set of adaptive weights 626 may correspond to weights or parameters of a machine learning model, such as an ensemble algorithm (e.g., a random forest or boosting), a decision tree, a regression model (e.g., linear or logarithmic), a Bayes model (e.g., a naïve Bayes classifier), among others. The adaptive weights 626 may be set or configured for a particular machine 510, and may be updated across different time windows (e.g., from a previous time window T_{B}). Each adaptive weight 626 may identify or include a value (denoted as wᵢ) to apply to a corresponding attribute 606 (denoted as Xᵢ). The values of the adaptive weights 626 may be updated based on the performance of the individual machine 510 and the corresponding attributes 606 from different time windows. The updating of the adaptive weights 626 will be detailed below.

In determining the adaptive score component 622B, the health evaluator 520 may apply the adaptive weight 626 to the corresponding attribute 606. In some embodiments, the health evaluator 520 may identify the parameters of the model (e.g., an ensemble random forest) to use as the set of adaptive weights 626 to apply to the corresponding attributes 606. The parameters used as the set of adaptive weights 626 may have been updated using the attributes 606 and the performance from the different time window. From applying, the health evaluator 520 may generate a product of the adaptive weight 626 with each corresponding attribute 606 (wᵢ×Xᵢ). With the generation, the health evaluator 520 may calculate a sum of the products across the set of attributes 606. Upon calculating, the health evaluator 520 may identify or use the sum as the adaptive score component 622B. As the adaptive weights 626 may differ from the static weights 624, the adaptive score component 622B may differ from the static score component 622A. The adaptive score component 622B may be included by the health evaluator 520 into the set of score components 622.

The health evaluator 520 may determine at least one model score component 622C by applying the session prediction model 550 to one or more of the set of attributes 606. The model score component 622C may indicate or identify a predicted probability of failure for sessions 604 provided by the machine 510. The session prediction model 550 may be implemented using a machine learning model, such as an artificial neural network (ANN) (e.g., an auto-encoder, deep learning, a convolutional neural network, or a transformer), a support vector machine (SVM), or a clustering algorithm (e.g., a k-nearest neighbors algorithm), among others. The session prediction model 550 may be trained and updated based on the performance of multiple machines 510 and the attributes 606 from different time windows. In some embodiments, the session prediction model 550 may be trained and updated using performance data and attributes 606 from multiple machines 510 over a time window longer than the time window for updating the adaptive scoring model 545. The training and updating of the session prediction model 550 will be detailed herein below.

In determining, the health evaluator 520 may feed the set of attributes 606 as inputs the session prediction model 550. The session prediction model 550 may include a set of inputs and a set of outputs related to one another via a set of weights and interconnections. The set of weights and the interconnections may be defined or configured in accordance with the machine learning model used to implement the session prediction model 550. The inputs may include one or more of the attributes 606 and the output may include the model score component 622C. In some embodiments, the inputs may include one or more of a number of different users using sessions 602 previously provided by the machine 510 and a number of different applications accessed via the sessions 602, among others. By feeding into the inputs, the health evaluator 520 may process the set of attributes 606 by applying the weights and interconnections as defined by the session prediction model 550. From applying the session prediction model 550, the health evaluator 520 may produce or generate the model score component 622C. The model score component 622C may be included by the health evaluator 520 into the set of score components 622.

With the determination, the health evaluator 520 may calculate, determine, or otherwise generate at least one health score 630 as a function of the set of score components 622. The health score 630 may indicate the performance of the machine 510 or the session 602 provided by the machine 510 over the time window (e.g., the time window T_{A}). In some embodiments, the health evaluator 520 may use a subset of score components 622 in determining the health score 630. The function may be defined using a set of score weights 628A-N (hereinafter generally referred to as score weights 628) corresponding to the set of score components 622. The score weights 628 may be set or configured for a particular machine 510 or may be applicable across multiple machines 510. Each score weight 628 may identify or include a value (denoted as Wᵢ) to apply to the respective score component 622 (e.g., denoted as W_{S} for the static score component 622A, W_{A} for the adaptive score component 622B, and W_{M} for the model score component 622C). The set of score weights 628 may sum to a defined value, such as unity (e.g., W_{S}+W_{A}+W_{M}=1). The score weights 628 may be configured and updated, as detailed herein below.

In determining the health score 630, the health evaluator 520 may apply the score weight 628 to the corresponding score component 622. From applying, the health evaluator 520 may generate a product of the score weight 628 with each corresponding score component 622. With the generation, the health evaluator 520 may calculate a sum of the products across the set of score components 622. The health evaluator 520 may identify or use the sum as the health score 630 for the machine 510. In some embodiments, the health evaluator 520 may produce or generate an association between the health score 630 and the machine 510 (or the sessions 602 provided by the machine 510). The association may be arranged using a data structure, such as a linked list, tree, array, table, hash table, queue, stack, or heap, among others. For example, the association may include an identifier for the machine 510 (e.g., a network address or device identifier) and the value for the health score 630. With the generation, the health evaluator 520 may store and maintain the health score 630 for the machine 510 on the database 535. In some embodiments, the health evaluator 520 may store and maintain the association between the health score 630 and the machine 510 on the database 535.

Referring now to FIG. 6C, depicted is a block diagram of a process 640 for applying classifications in the system 500 for classifying machines by performance levels. The process 640 may correspond or include operations in the system 500 for using the health scores to provide information on the classification of the machine. Under the process 640, the performance classifier 525 may identify, determine, or otherwise classify the machine 510 into one of a set of performance levels 642 in accordance with the health score 630. The performance level 642 may correspond to or may be an indicator of the performance of the machine 510 or the sessions 602 provided by the machine 510 associated with a range of health scores. For example, the set of performance levels 642 may include a set of strings: “excellent” for the first quartile of health scores 630; “good” for the second quartile; “fair” for the third quartile; and “poor” for the lowest quartile. To classify, the performance classifier 525 may compare the health score 630 with the range of health scores for each performance level. The health score 630 may have a value corresponding to the range of health scores for one of the performance levels. From the comparison, the performance classifier 525 may identify the performance level 642 for which the health score 630 is within the specified range of values. According to the identification, the performance classifier 525 may classify the machine 510 into the performance level 642.

With the classification, the performance classifier 525 may generate an association between the performance level 642 and the machine 510 (or the sessions 602 provided by the machine 510). The association may be arranged using a data structure, such as a linked list, tree, array, table, hash table, queue, stack, or heap, among others. For example, the association may include an identifier for the machine 510 (e.g., a network address or device identifier) and the value for the performance level 642. With the generation, the performance classifier 525 may store and maintain the association on the database 535. In some embodiments, the performance classifier 525 may produce or generate at least one output 644 to the administrator device 555 based on the performance level 642 for the machine 510 (or the association). The output 644 may include or identify information associated with one or more machines 510, such as the health score 630, the performance level 642, the associations, an identifier for each machine 510, and an identifier for the sessions 602 provided by the machine 510, among others. With the generation, the performance classifier 525 may send, convey, or otherwise provide the output 644 to the administrator device 555.

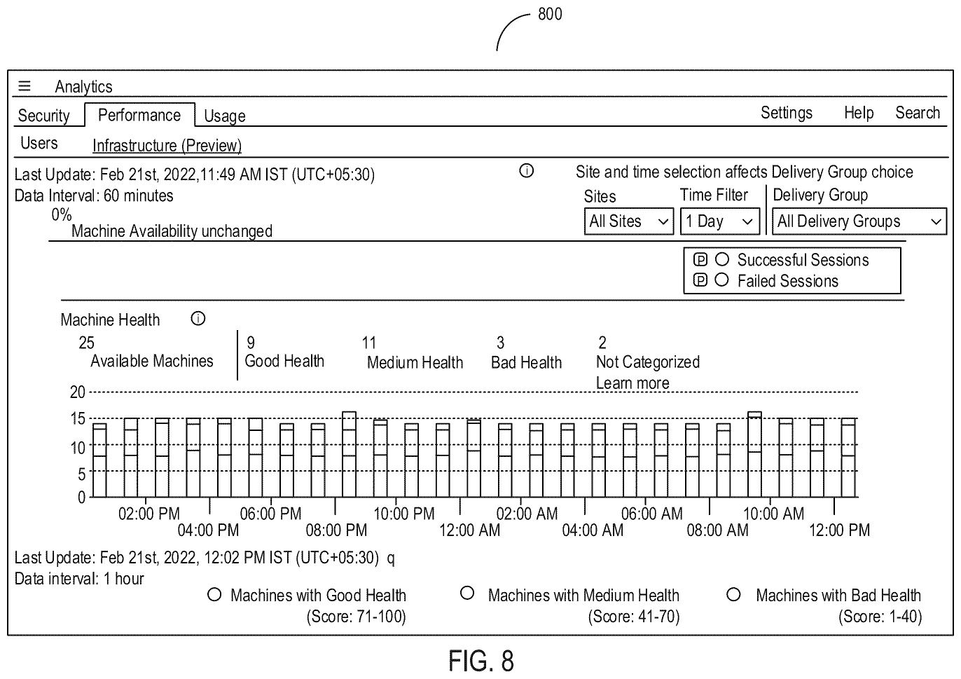

The administrator device 555 may retrieve, receive, or otherwise identify the output 644 from the machine assessment service 505. With the receipt, the administrator device 555 may parse the output 644 to extract or identify the performance level 642 for the machine 510. In some embodiments, the administrator device 555 may parse the output 644 to identify information associated with machine 510. From the output 644, the administrator device 555 may display or present the information (e.g., the performance level 642) via at least one interface 646. The interface 646 may be a graphical user interface (GUI) of an application running on the administrator device 555. The interface 646 may be used to present information and various data regarding each machine 510, the session 602, the health score 630, and the performance level 642 determined for the machine 510, among others. An example of the interface 646 is described herein in conjunction with FIG. 8.

In some embodiments, the administrator device 555 (or the performance classifier 525) may produce or generate at least one correction factor 648 to adjust, set, or otherwise modify the health score 630 based on the performance level 642. The administrator device 555 may compare the performance level 642 (or the health score 630) with an indication of actualized performance on the machine 510 or the session 602. The indication of realized performance may identify or include, for example, a failure to launch sessions 602, a notification of poor user experience from the user on the client 102, or observations of the sessions 602 by the user of the administrator device 555. In some embodiments, the administrator device 555 may detect or receive one or more inputs via the interface 646 for the indication of realized performance. Based on the comparison, the administrator device 555 may identify or determine the correction factor 648. The correction factor 648 may correspond to a deviation, discrepancy, or otherwise difference between the performance level 642 and the actualized performance at the machine 610. The correction factor 648 may be a numerical value by which the health score 630 is to be adjusted of modified. The administrator device 555 may send, transmit, or otherwise provide the correction factor 648 to the health evaluator 520.

The health evaluator 520 may adjust, set, or otherwise modify the health score 630 in accordance with the correction factor 648. Upon receipt, the health evaluator 520 may use or apply the correction factor 648 to determine or generate the modified health score 630. From applying, the health evaluator 520 may calculate a new sum of the product of the score weight 628 with each corresponding score component 622 and the correction factor 648. In some embodiments, the health evaluator 520 may update the association to include the modified health score 630. The association may be between the modified health score 630 and the machine 510. The modified health score 630 and the association may be stored and maintained on the database 535. Upon updating, the health evaluator 520 may send or provide the modified health score 630 to the performance classifier 525. The performance classifier 525 in turn may repeat the classification of the machine 510 into one of the performance levels 642 using the new, modified health score 630.

In some embodiments, the administrator device 555 (or the performance classifier 525) may produce or generate at least one instruction 650 based on the performance level 642. The instruction 650 may be used to modify or configure the machine 510 or the session 602 provided by the machine. For example, the instruction 650 may include allocation of computing resources (e.g., processor or memory) to the machine 510 or the session 602; closure of processes (e.g., applications and threads) running on the machine 510; settings for the rendering of the virtual desktop 604 communicated via the session 602; termination of the session 602 between the client 102 and the machine 510; and notification to the user of the client 102 of poor performance at the machine 510, among others. In some embodiments, the instruction 650 may be generated using inputs for generating the instruction 650 received via the interface 646. Upon generation, the administrator device 555 may send, transmit, or otherwise provide the instruction 650 to the machine 510. Upon receipt, the machine 510 may perform or carry out the instruction 650 to configure the machine 510 itself or the session 602 provided by the machine 510.

Referring now to FIG. 6D, depicted is a block diagram of a process 660 for managing scoring schemes in the system 500 for classifying machines by performance levels. The process 660 may include or correspond to operations in the system 500 for initializing, establishing, and updating the scoring schemes used to determine the health scores and performance levels. Under the process 660, the model handler 530 executing on the machine assessment service 505 may initiate, establish, and update the scoring schemes used to generate the health score 630, such as the static scoring function 540, the adaptive scoring model 540, and the session prediction model 550 as well as the set of score weights 628, among others.

The model handler 530 may initiate and establish the adaptive scoring model 545. In establishing the adaptive scoring model 545, the model handler 530 may set or assign values for the set of adaptive weights 626. The value for each adaptive weight 626 may be assigned to a random value, to be equal as the static weights 624, or an initially defined value, among others. In some embodiments, the model handler 530 may train the adaptive scoring model 545 using a training dataset. The training may be in accordance with unsupervised or supervised learning, among others. For example, the adaptive scoring model 545 may be a random forest, the adaptive weights 626 may correspond to the weights of the random forest mode, and the training of the random forest may be in accordance with ensemble learning. The training dataset may include multiple sets of attributes 606 from different machines 510 and an expected value for the adaptive score component 622B for a given set of attributes 606. To train, the model handler 530 may apply each set of attributes 606 from the training dataset to the adaptive weights 626 of the adaptive scoring model 545 to calculate a value for the adaptive score component 622B. The model handler 530 may determine an error metric based on a difference between the expected value as identified in the training dataset for the given set of attributes 606 and the produced value. The model handler 530 may update the adaptive weights 626 based on the error metric, and repeat the application under a convergence condition for the set of adaptive weights 626 of the adaptive scoring model 545. With the establishment, the adaptive scoring model 545 may be used to determine the adaptive score components 622B for new sets of attributes 606.

In addition, the model handler 530 may initiate and establish the session prediction model 550. As discussed above, the session prediction model 550 may include a set of inputs and a set of outputs related to one another via a set of weights and interconnections arranged in accordance with a machine learning model. In establishing, the model handler 530 may train the session prediction model 550 using a training dataset. The training dataset may identify multiple sets of attributes 606 from different machines 510 and an expect value of the predicted probability of failure for the model score component 622C. In some embodiments, the training dataset may include a number of different users from sessions 602 provided by a given machine 510 and a number of applications accessed in each session 602, and a status indicating a success or failure in launching the session 602 on a given machine 510, among others.

Continuing on, the model handler 530 may apply each set of attributes 606 from the training dataset to the session prediction model 550 to produce a value of the predicted probability of failure. In some embodiments, the model handler 530 may also apply the number of different users and the number of applications, among others. Upon production, the model handler 530 may compare the value outputted by the session prediction model 550 with the expected value as identified in the training dataset for the given set of attributes 606. In some embodiments, the model handler 530 may compare the outputted value with the status indication identified for the given set of attributes 606 in the training dataset. Based on the comparison, the model handler 530 may determine an error metric indicating a degree of deviation from the expected value. The model handler 530 may update the weights in the session prediction model 550 based on the error metric, and repeat the application under a convergence condition for the weights of the session prediction model 550. With the establishment, the session prediction model 550 may be used to determine the model score components 622C for new sets of attributes 606 as discussed above.

To update the scoring schemes, the model handler 530 may retrieve, receive, or otherwise identify feedback data 662. The feedback data 662 may identify or include a set of attributes 606′A-N (hereinafter generally referred to as attributes 606′). The set of attributes 606′ for updating may differ from the set of attributes 606 used to determine the performance level 642. The set of attributes 606′ may be for the same machine 510 for which the performance level 642 is determined. In some embodiments, the set of attributes 606′ may be for a set of machines 510, including or excluding the same machine 510 for which the performance level 642 is determined. Similar to the set of attributes 606, the set of attributes 606′ may identify or include attributes 606′ identifying a resource consumption; attributes 606′ correlated with or identifying user experience; and attributes 606′ correlated with or identifying a failure of one or more sessions 602, among others. The set of attributes 606′ may be for a time window T_{B} different from the time window T_{A} for the set of attributes 606. The time window T_{B} may be prior to (e.g., when the scoring scheme is updated before the determination of the performance level 642), subsequent to (e.g., when the scoring scheme is updated after the determination of the performance level 642), or concurrent with (e.g., overlapping at least in part or encompassing) the time window T_{A}. The time window T_{B} may have a span between minutes to weeks, and may be for example, an hour, a day, a set number of days, or a week, among others. The time window T_{B} may be the same or may differ from the time window T_{A}.

Furthermore, the feedback data 662 identified by the model handler 530 may identity or include at least one status 664 for the machine 510 for which the performance level 642 is determined. In some embodiments, the status 664 may be for each machine 510 of a set of machines 510, including or excluding the machine 510 for which the performance level 642 is determined. The status 664 may identify or indicate whether success or failure of the session 602 provided by the corresponding machine 510 in launching. The status 664 may be identified at a time subsequent to the determination of the performance level 642 for the machine 510. The model handler 530 may access or interface with the machine 510 or the session 602 to determine or identify the status 664. At the time of identification, if the session 602 provided by the machine 510 has failed in launching, the status 664 for the machine 510 may indicate failure of the session 602 in launching. Conversely, if the session 602 provided by the machine 510 has succeeded in launching (e.g., running currently), the status 664 for the machine 510 may indicate success of the session 602 in launching. In some embodiments, the model handler 530 may set or assign at least one score value based on the identified status 664. The score value may represent a score component 622 given the status 664. The model handler 530 may assign one value when the status 664 indicates success and another value when the status 664 indicates failure.

Using the feedback data 662, the model handler 530 may modify, change, or otherwise update the set of adaptive weights 626 of the adaptive scoring model 545. The updating of the adaptive weights 626 for the adaptive scoring model 545 may be performed at a time interval. The time interval may span between minutes to weeks. For example, the time interval may correspond to the time window T_{B} over which the sets of attributes 606′ for the feedback data 662 are identified. To update, the model handler 530 may identify the set of attributes 606′ for the machine 510 associated with the given set of adaptive weights 626. As discussed above, the adaptive weights 626 may be particular to a given machine 510. In addition, the model handler 530 may identify the status 664 (or the score value) associated with the same machine 510.

With the identification, the model handler 530 may apply the set of attributes 606′ to the corresponding set of adaptive weights 626 of the adaptive scoring model 545 to determine a value for the adaptive scoring component 622B. The model handler 530 may compare the outputted adaptive scoring component 622B with the status 664 for the machine 510. In some embodiments, the model handler 530 may compare the outputted adaptive scoring component 622B with the score value determined using the status 664. Based on the comparison, the model handler 530 may determine an error metric based on a difference between the adaptive scoring component 622B and the expected score value. Using the error metric, the model handler 530 may update the set of adaptive weights 626 of the adaptive scoring model 545. The model handler 530 may repeat the updating using the sets of attributes 606 over multiple machines 510 for the respective sets of adaptive weights 626.

In addition, the model handler 530 may modify, change, or otherwise update the session prediction model 550. The updating the session prediction model 550 may be performed in conjunction or separately from the updating of the adaptive scoring model 545. The updating of the session prediction model 550 may be performed at a time interval. The time interval may correspond to the time window T_{B} over which the sets of attributes 606′ for the feedback data 662 are identified. The time interval for the updating of the session prediction model 550 may differ from the time interval for the updating of the adaptive scoring model 545. For example, the time interval may be longer in duration such that the feedback data 662 is accumulated over a greater span of time for the updating of the session prediction model 550. For the session prediction model 550, the feedback data 662 may include sets of attributes 606′ and statuses 664 over a greater span of time, relative to the feedback data 662 used to update the adaptive scoring model 545. The sets of attributes 606′ and statuses 664 may be also obtained from multiple machines 510 and sessions 602 provided by the machines 510.

Continuing on, the model handler 530 may apply each of the set of attributes 606′ from the feedback data 662 to the session prediction model 550 to output a value of the predicted probability of failure for the model score component 622C. Upon outputting, the model handler 530 may compare the value outputted by the session prediction model 550 with the status 664 for the machine 510 associated with the set of attributes 606′ applied to output the value. In some embodiments, the comparison may be between the value outputted by the session prediction model 550 and the score value determined based on the status 664. Based on the comparison, the model handler 530 may determine an error metric indicating a degree of deviation from the expected value. The model handler 530 may update the weights in the session prediction model 550 based on the error metric, and repeat the application over the remaining sets of attributes 606′ and statuses 664 in the feedback data 662.

The model handler 530 may also use at least one configuration 666 to reset, modify, or otherwise update the scoring schemes from the administrator device 555. In some embodiments, the model handler 530 may retrieve, receive, or identify at least one configuration 666. The configuration 666 may indicate one or more values for the set of static weights 624, the set of adaptive weights 626, and the score weights 628. The configuration 666 may be independent from the feedback data 662. In some embodiments, the administrator device 555 may produce or generate the configuration 666 using one or more inputs received via the interface 646 to provide to the model handler 530 (e.g., as depicted). For example, the interface 646 may provide a set of user interface elements (e.g., sliders) to adjust or set the values of the set of static weights 624, the set of adaptive weights 626, and the score weights 628, among others. The user of the administrator device 555 may indicate that the weight 628 for the static score component 622A is to be given a higher value than the weights 628 for the adaptive score component 622B and the model score component 622C respectively via the interface 646. The entry of the values for the weights may be a failsafe measure to ensure that drifts in the adaptive weights 626 or the parameters in the session prediction model 550 do not negatively impact the determination of the health scores 630 and the classifications of the performance levels 642. Using the entry of inputs through the interface 646, the administrator device 555 may generate the configuration 666. Upon generation, the administrator device 555 may send, convey, or otherwise provide the configuration 666 to the machine assessment service 505.

In some embodiments, the model handler 530 may determine or generate the configuration 666 using the performance levels 624 determined over multiple machines 510. To generate, the model handler 530 may calculate or determine a quality measure for the performance levels 642 generated by the performance classifier 525. The quality metric may be for the performance levels 624 determined over multiple machines 510 over a given time window (e.g., the time window T_{B} as discussed above). The quality metric may include, for example, accuracy, precision, or recall, among others. The determination of the quality metric may be based on the determined performance levels 624, the health scores 630, the set of attributes 606 for the associated machines 510 and sessions 602, and the correction factors 648, among others. Using the quality metric, the model handler 530 may calculate or determine the one or more values to apply for the set of static weights 624, the set of adaptive weights 626, and the score weights 628. For example, the quality metric may indicate a degree of sensitivity or recall in the performance level 624 classifications or the health scores 630, given the set of attributes 606 used as input. In this example, when the measure of recall is above a threshold for the attributes 606 related to session trends, the model handler 530 may set the values to decrease or null the corresponding static weight 624 or adaptive weight 626. The model handler 530 may insert or include the determined values into the configuration 666.

In accordance with the configuration 666, the model handler 530 may adjust, set, or otherwise update the set of static weights 624, the set of adaptive weights 626, or the score weights 628, among others. To update, the model handler 530 may apply the values specified in the configuration 666 to the corresponding scoring scheme. For example, when the configuration 666 identifies values to apply to the set of static weights 624, the model handler 530 may set the set of static weights 624 to the corresponding values. When the configuration 666 identifies values to apply to the set of adaptive weights 626, the model handler 530 may set the set of adaptive weights 626 to the corresponding values. When the configuration 666 identifies values to apply to the set of adaptive weights 626, the model handler 530 may set the set of score weights 628 to the corresponding values.

In some embodiments, the model handler 530 may adjust, set, or otherwise update the range of health scores 630 for each performance level 642. As discussed above, each performance level 642 may correspond or be associated with a range of health scores 630. To update, the model handler 530 may identify or determine a distribution of health scores 630 determined for multiple machines 510 or sessions 604. The health scores 630 may be those determined during a time window (e.g., the time window T_{B} as discussed above). Based on the distribution, the model handler 530 may set, define, or otherwise determine ranges of health scores 630 for the corresponding performance levels 642. For example, the model handler 530 may identify a value for the health score 630 corresponding to a top quartile in the distribution. The model handler 530 may use the identified value to define the range of health scores 630 for the performance level 642 of “excellent.” With the determination, the ranges of heath scores for the performance levels 642 may be used in subsequent determinations and classifications.

By taking into account the various attributes 606, such as resource consumption, user experience, and session performance trends, the health scores 630 may represent a single measure of performance for the machine 510. The schema for scoring may leverage both domain-knowledge in the form of static scoring function 535 as well as data-based insights using machine learning approaches in the form of the adaptive scoring model 540 and the session prediction model 550. The combination of the machine learning approach with the fail-safe methodology based on domain knowledge may provide a defense against common pitfalls for machine learning techniques. The health scores 630 and the performance levels 642 may be used by a manager of system as a guideline for troubleshooting, load balancing, resource provision, and virtual desktop assignment, among others (e.g., using the interface 646 and the instruction 650). This may improve the performance of the overall system including the individual machine 510 and the user experience of accessing various resources through the sessions 602 provided by the machines 510

Referring now to FIGS. 7A and 7B, depicted are block diagrams of a function 700 and 705 to weigh session statuses by recency for calculation of session trend. The function 700 as depicted in FIG. 7A may be for weighted average is an average that has multiplying factors to give different weights to data at different positions in the sample window. The function 705 as depicted as in FIG. 7B may be for an exponential moving average (EMA) that is a first-order infinite impulse response filter that applies weighting factors which decrease exponentially.

Referring now to FIG. 8, depicted is a screenshot of an interface 800 for providing information on classifications of machines by performance levels in the system 500. The interface 800 may be an example of the interface 646 discussed above. The interface 800 may display various information related to a given group of machines 510. As depicted, the interface 800 may identify the number of machines 510 classified as “good health,” “medium health,” “bad health,” and “not categorized.” The classifications may have been determined using the set of attributes 606 for each machine 510 in the group. The definitions for the health scores 630 into the classification into the performance levels 642 may also be presented in the interface 800.

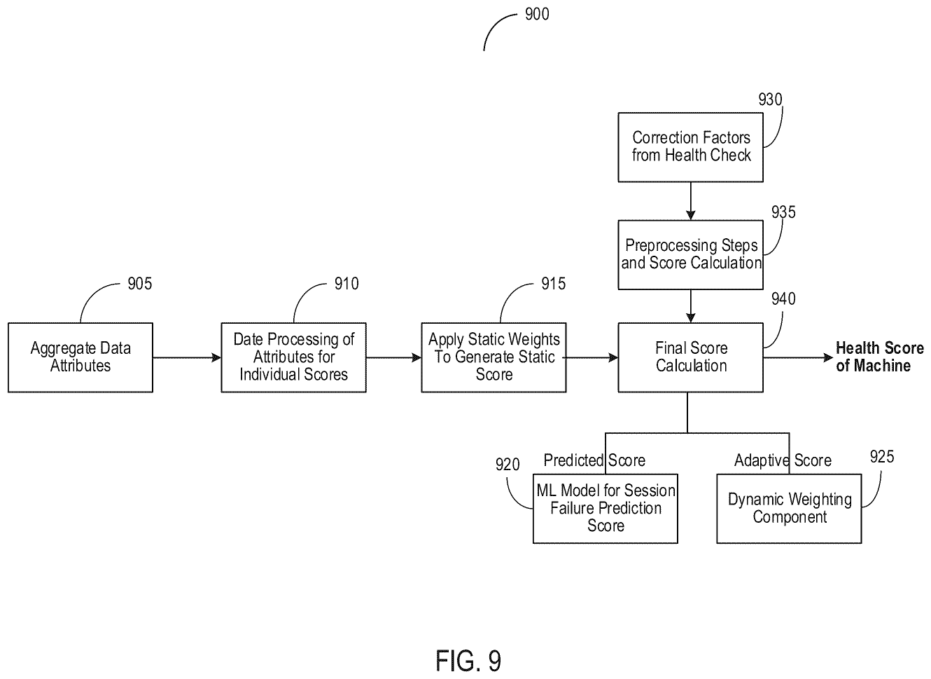

Referring now to FIG. 9, depicted is a flow diagram of a process 900 of determining health scores of machines. The functionalities of process 900 may be implemented using, or performed by, the components described in FIGS. 1-6D, such as the machine assessment service 505. In overview, a service (e.g., the machine assessment service 505) may aggregate attributes (905). The service may perform processing of attributes for individual scores and may generate (910). The service may apply static weights to attributes to generate a static score (915). The service may use a machine learning (ML) model for failure prediction score (920). The service may use dynamic weighting component to generate an adaptive score (925). The service may identify correction factors from health check (930). The service may preprocessing steps and score calculations (935). The service may amalgamate the scores and the correction factors to generate the health score of the machine (940).

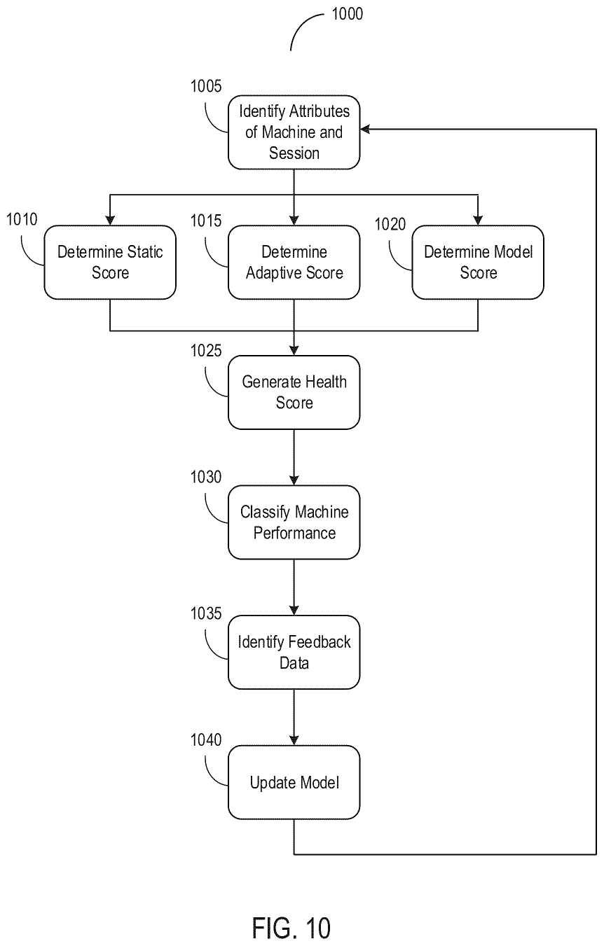

Referring now to FIG. 10, depicted is a flow diagram a method 1000 of classifying machines by performance levels based on comprehensive health scores. The functionalities of method 1000 may be implemented using, or performed by, the components described in FIGS. 1-6D, such as the machine assessment service 505. In overview, a service (e.g., the machine assessment service 505) may identify attributes (e.g., the attributes 606) of a machine (e.g., the machine 510) and a session (e.g., the session 602) provided by the machine (1005). The service may determine a static score (e.g., the static score component 622A) (1010). The service may determine an adaptive score (e.g., the adaptive score component 622B) (1015). The service may determine a model score (e.g., the mode score component 622C) (1020). The service may generate a health score (e.g., the health score 630) (1025). The service may classify the machine by performance (1030). The service may identify feedback data (e.g., the feedback data 662) (1035). The service may update the models (e.g., the static scoring function 540, the adaptive scoring model 545, and the session prediction model 550) (1040).

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

It will be further understood that various changes in the details, materials, and arrangements of the parts that have been described and illustrated herein may be made by those skilled in the art without departing from the scope of the following claims.

1. A method of classifying a machine by performance, comprising:
identifying, by a device, for a first time window, a first plurality of attributes of a machine and a session provided by the machine;
determining, by the device, a first score based at least on a weight applied to each of the first plurality of attributes, the weight updated using a second plurality of attributes of the machine and the session provided by the machine for a second time window;
determining, by the device, a probability of failure for the session by applying at least one of the first plurality of attributes to a model;
generating, by the device, a second score indicating a performance of the machine as a function of the first score and the probability of failure; and
classifying, by the device, the machine into one of a plurality of performance levels in accordance with the second score.

2. The method of claim 1, further comprising determining, by the device, a third score based at least on a second weight applied to each of the first plurality of attributes, the second weight maintained through the first time window and the second time window, and
wherein generating the second score further comprises generating the second score as the function of the first score, the probability of failure, and the third score.

3. The method of claim 1, further comprising identifying, by the device, via an interface, a factor to indicate a difference between the second score and the performance of the machine, and
wherein generating the second score further comprises modifying the second score in accordance with the factor.

4. The method of claim 1, further comprising determining, by the device, for the first plurality of attributes, an attribute indicating a trend of session failure as a second function to weigh a status for each of a plurality of sessions previously provided by the machine by recency.

5. The method of claim 1, further comprising training, by the device, the model for determining the probability of failure using a dataset comprising: at least one of a number of different users from a plurality of sessions previously provided by the machine, a number of different applications accessed via one of the plurality of sessions, and a status for each of the plurality of sessions.

6. The method of claim 1, further comprising updating, by the device, a second model including the weight to be applied, using the second plurality of attributes of the machine and a third score generated indicating the performance of the machine during the second time window.

7. The method of claim 1, further comprising providing, by the device, output based at least on a classification of the machine into one of the plurality of performance levels.

8. The method of claim 1, wherein determining the probability of failure for the session further comprises applying at least one of the first plurality of attributes to the model, the model updated using a third plurality of attributes of the machine and the session provided by the machine for a third time window greater than the second time window.

9. The method of claim 1, wherein generating the second score further comprises applying a second weight to the first score and a third weight to the probability of failure, the second and the third weight updated from a third time window.

10. The method of claim 1, wherein the first plurality of attributes comprises a first attribute identifying a consumption of a resource of the machine, a second attribute identifying a user experience of the session provided by the machine, and a third attribute identifying a failure of the session.

11. A system for classifying a machine by performance, comprising:
a device having one or more processors coupled with memory, configured to:
identify, for a first time window, a first plurality of attributes of a machine and a session provided by the machine,
determine a first score based at least on a weight applied to each of the first plurality of attributes, the weight updated using a second plurality of attributes of the machine and the session provided by the machine for a second time window;
determine a probability of failure of the session by applying at least one of the first plurality of attributes to a model;
generate a second score indicating a performance of the machine as a function of the first score and the probability of failure; and
classify the machine in to one of a plurality of performance levels in accordance with the second score.

12. The system of claim 11, wherein the device is further configured to:
determine a third score based at least on a second weight applied to each of the first plurality of attributes, the second weight maintained through the first time window and the second time window, and
generate the second score as the function of the first score, the probability of failure, and the third score.

13. The system of claim 11, wherein the device is further configured to identify, via an interface, a factor to indicate a difference between the second score and the performance of the machine, and modify the second score in accordance with the factor.

14. The system of claim 11, wherein the device is further configured to determine, for the first plurality of attributes, an attribute indicating a trend of session failure as a second function to weigh a status for each of a plurality of sessions previously provided by the machine by recency.

15. The system of claim 11, wherein the device is further configured to train the model for determining the probability of failure using a dataset comprising: at least one of a number of different users from a plurality of sessions previously provided by the machine, a number of different applications accessed via one of the plurality of sessions, and a status for each of the plurality of sessions.

16. The system of claim 11, wherein the device is further configured to update a second model including the weight to be applied, using the second plurality of attributes of the machine and a third score generated indicating the performance of the machine during the second time window.

17. The system of claim 11, wherein the device is further configured to provide output based at least on a classification of the machine into one of the plurality of performance levels.

18. A non-transitory computer readable medium storing program instructions for causing one or more processors to:
identify, for a first time window, a first plurality of attributes of a machine and a session provided by the machine,
determine a first score based at least on a weight applied to each of the first plurality of attributes, the weight updated using a second plurality of attributes of the machine and the session provided by the machine for a second time window;
determine a probability of failure of the session by applying at least one of the first plurality of attributes to a model;
generate a second score indicating a performance of the machine as a function of the first score and the probability of failure; and
classify the machine in to one of a plurality of performance levels in accordance with the second score.

19. The non-transitory computer readable medium of claim 18, wherein the instructions further cause the one or more processors to determine, for the first plurality of attributes, an attribute indicating a trend of session failure as a second function to weigh a status for each of a plurality of sessions previously provided by the machine by recency.

20. The non-transitory computer readable medium of claim 18, wherein the instructions further cause the one or more processors to provide output based at least on a classification of the machine into one of the plurality of performance levels.
